(19) United States
(12) Patent Application Publication
(10) Pub. No.: US 2005/0263007 A1
(43) Pub. Date: Dec. 1, 2005

(54) Automatic cup type beverage vending machine

(75) Inventors: Takayuki Akuzawa, Gunma-gun (JP); Isao Ishizaki, Isesaki-shi (JP); Kimihisa Ishikawa, Sawa-gun (JP)

Correspondence Address: BANNER & WITCOFF, 1001 G STREET N W, SUITE 1100, WASHINGTON, DC, 20001, US

(73) Assignee: Sanden Corporation, Isesaki-Shi (JP)

(21) Appl. No.: 11/138,394

(22) Filed: May 27, 2005

(30) Foreign Application Priority Data
May 27, 2004 (JP) 157301/2004

(51) Int. Cl. A47J 31/00

(52) U.S. Cl. 99/279

(57) ABSTRACT

An automatic cup type beverage vending machine which, even where the same kind of beverage are sold through a plurality of vending machines, prevents variations in the taste of the same kind of beverage from one machine to another is to be provided. Since it is so configured that beverage data stored in a memory unit 11 can be replaced with new beverage data by receiving beverage data transmitted from a headquarters server S1 through via a medium of communication or only by storing beverage data transmitted from a headquarters server S1 to sales office servers S2 into an external memory M2 and reading the beverage data from the memory M2 connected to a connection unit 16, the beverage data are not altered arbitrarily on the part of the manager (an operator or the like) of the vending machine, and beverages can be prepared always on the basis of predetermined beverage data.

### BACKGROUND OF THE INVENTION

(i) Field of the Invention

The present invention relates to an automatic cup type beverage vending machine for selling various beverages including different types of coffee, refreshments and carbonated drinks, contained in a cup.

(ii) Description of the Related Art

Known automatic cup type beverage vending machines of this kind include one in which materials of different beverages are held in a plurality of material containers and a material delivered from its container is diluted with water, hot or cold, to prepare a prescribed beverage for sale, which is poured into a cup and offered to the buyer (see, for instance, Japanese Patent Publication No. 11-283114).

In this vending machine the quantities of the material and diluting liquid, the duration of agitating and other factors of the preparation method are stored as beverage data for each type of beverage, and the beverage selected by each buyer is prepared at the time of sale on the basis of the beverage data. When a prescribed type of coffee is to be prepared for instance, prescribed quantities of ground coffee, sugar and cream are tapped from their respective containers on the basis of the beverage data on that type of coffee, and their mixture is stirred while being diluted with a prescribed quantity of hot water.

Incidentally, since the beverage data in the vending machine can be rewritten via a prescribed manipulating unit on the machine, the beverage data including the quantities of materials to be used may be arbitrarily modified by the operator of a vending machine or somebody else, with the result that the taste of the same kind of beverage vary from one vending machine to another. However, the same dealer may sell the same kinds of beverages through a plurality of vending machines, and if the tastes of the same kinds of beverages are allowed to be modified from one machine to another, it will become impossible to keep the quality of each kind of beverage uniform among all the vending machines.

### SUMMARY OF THE INVENTION

An object of the present invention, attempted in view of the problem noted above, is to provide an automatic cup type beverage vending machine which, even where the same kinds of beverages are sold through a plurality of vending machines, their tastes may not vary from one machine to another.

In order to achieve the object stated above, an automatic cup type beverage vending machine according to the invention comprises at least one material container for holding a beverage material and beverage data memory means storing, for each kind of beverage, a set of beverage data on the basis of which a beverage is prepared from the material in the material container, and sells the beverage which is prepared on the basis of the beverage data in the beverage data memory means, the beverage being contained in a cup when it is sold, the automatic cup type beverage vending machine being further provided with rewrite restricting means which allows beverage data stored in the beverage data memory means to be replaced with another set of beverage data only by prescribed beverage data rewriting means.

Since this configuration allows beverage data stored in the beverage data memory means to be replaced with another set of beverage data only by prescribed beverage data rewriting means, beverage data cannot be arbitrarily altered on the part of the manager (the operator or the like) of the vending machine.

Since beverage data cannot be arbitrarily altered according to the invention, it is possible to prepare beverages always on the basis of predetermined beverage data. Therefore, even where the same kinds of beverages marketed by a specific dealer are sold through a plurality of vending machines, their tastes do not vary from one machine to another and the quality of the merchandise can be kept uniform all the time.

### BRIEF DESCRIPTION OF THE DRAWINGS

FIG. 1 shows a front view of an automatic cup type beverage vending machine, which is a preferred embodiment of the present invention;

FIG. 2 is a schematic configurative diagram of the automatic cup type beverage vending machine;

FIG. 3 is a block diagram of the control arrangement;

FIG. 4 shows a front view of a display on the display unit when restricting modifications; and

FIG. 5 shows a front view of a display on the display unit when the restriction has been lifted.

### DESCRIPTION OF THE PREFERRED EMBODIMENTS

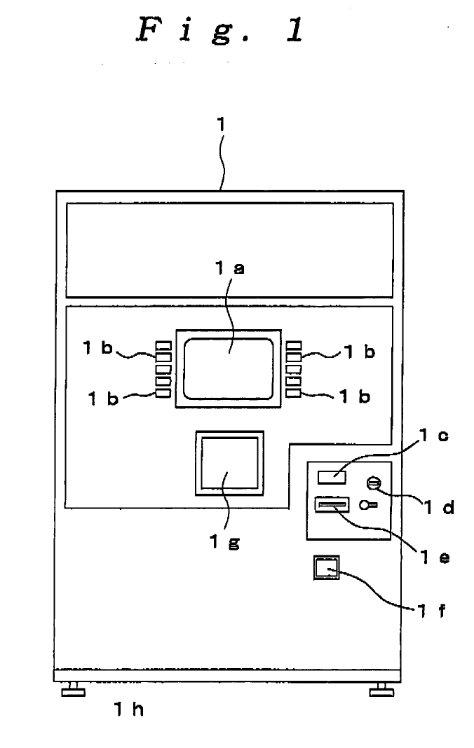

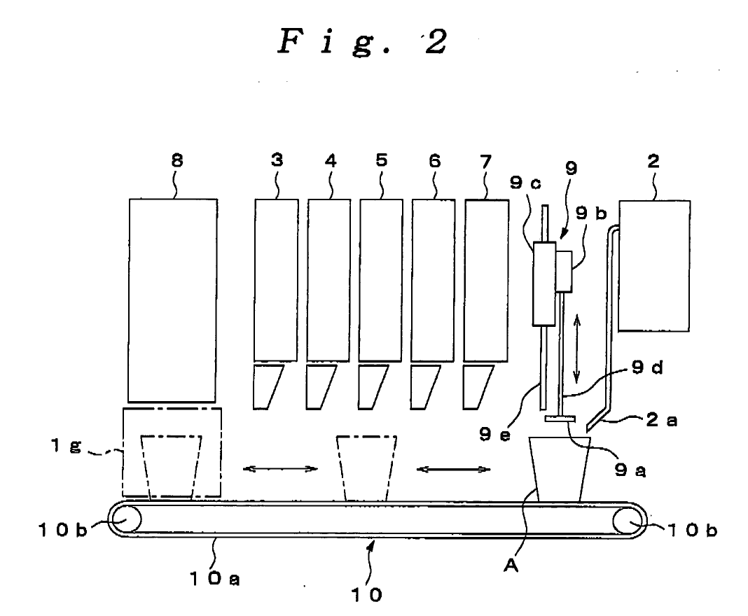

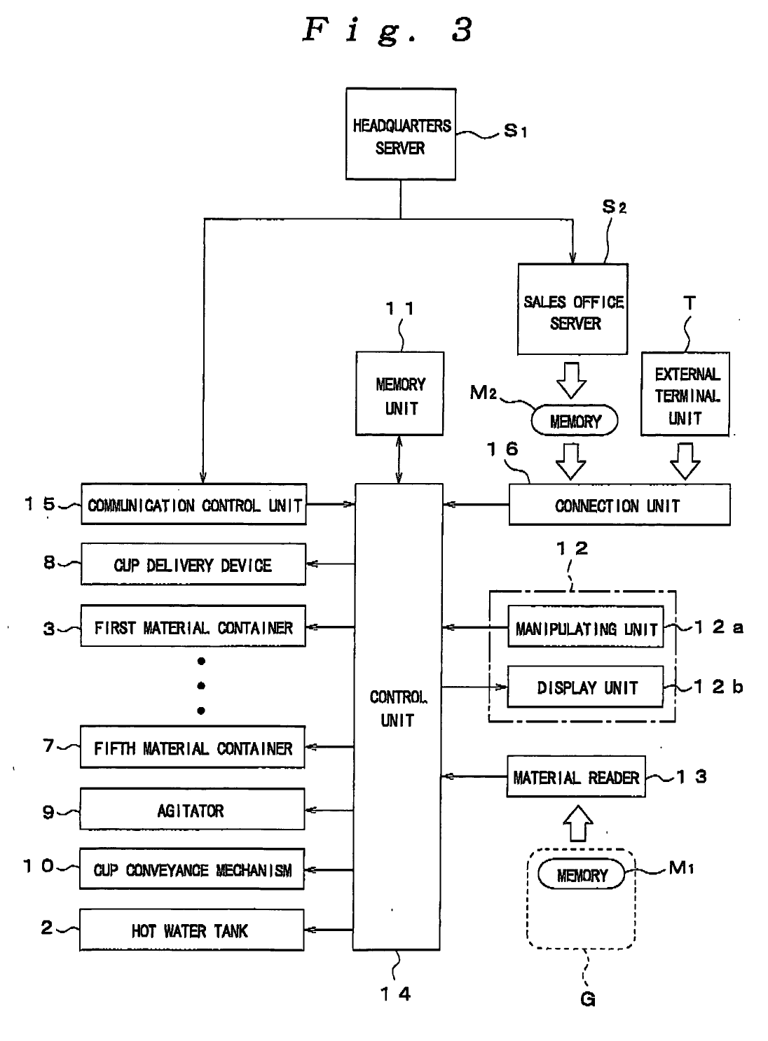

FIG. 1 through FIG. 5 illustrate a preferred embodiment of the present invention. This automatic beverage vending machine comprises a vending machine body 1, a hot water tank 2 for supplying hot water, first through fifth material containers 3 through 7 for holding beverage materials, a cup delivery device 8 for delivering cups A, an agitator 9 for agitating beverages, a cup conveyance mechanism 10 for conveying cups A, a memory unit 11 for storing beverage data and material data, a remote controller 12 for performing any desired setting, a material reader 13 capable of reading material data, and a control unit 14 for controlling beverage preparation on the basis of beverage data and material data. The control unit 14 stores programs as data rewriting means, rewrite restricting means, ciphered data deciphering means, determining means and sale restricting means.

The front panel of the vending machine body 1, formed to be openable, is provided with a screen display device 1a consisting of a liquid display or the like, a plurality of selector switches 1b arranged on both sides of the screen display device 1a in the widthwise direction, a monetary Bun display unit 1c, a coin slot 1d, a paper money slit 1e, a coin return pocket 1f and a beverage delivery outlet 1g. The screen display device 1a displays samples of available beverages and taste options (with sugar, with cream, black and so forth) and the selector switches 1b positioned to match these displayed options allow selection of the beverage and its optional taste.

The hot water tank 2, generating hot water of a prescribed temperature with a heater (not shown), discharges a prescribed quantity of the hot water so generated through a nozzle 2a.

The material containers 3 through 7 contain materials in powder form, and deliver materials, each in any desired quantity, downward via a material chute, In this process, the first through third material containers 3 through 5 hold different kinds of coffee powder: the first material container 3 contains the material for coffee D1, the second material container 4, that for coffee D2 and the third material container 5, that for coffee D3; the fourth material container 6 contains sugar and the fifth material container 7, cream.

The cup delivery device 8 has a known configuration for accommodating cups A for selling beverages, and delivers downward the cups A one by one.

The agitator 9 comprises a screw-shaped agitating member 9a for agitating the beverage, a motor 9b for rotating the agitating member 9a and an elevating mechanism 9c for moving the agitating member 9a in the vertical directions. The agitating member 9a is fitted to the lower end of a rotation shaft 9d extending in the vertical directions, while the upper end of the rotation shaft 9d is linked to the motor 9b. The elevating mechanism 9c is disposed to be movable in the vertical directions along a guide shaft 9e, to be moved in the vertical directions by a drive mechanism (not shown) together with the motor 9b and the agitating member 9a.

The cup conveyance mechanism 10 comprises an endless belt 10a extending in the widthwise direction and a pair of pulleys 10b in the widthwise direction turnably supporting the belt 10a. By driving the pulleys 10b with a motor (not shown), a cup A mounted on the upper face of the belt 10a is moved in the widthwise direction.

The memory unit 11 stores predetermined beverage data for preparing beverages, separately for each kind of beverage, and the kinds of materials held in the material containers 3 through 7 as material data, and these sets of data can be rewritten by the control unit 14. In this case, the memory unit 11 stores, for instance, the kinds of beverages (such as characters and image data expressing the name of each beverage), the kinds of materials to be used (such as main materials, auxiliary materials and diluting liquids), the quantities of materials to be used (such as the weight of each material) and the preparing method (such as the operations to put in materials and agitate) as beverage data.

The remote controller 12, having a manipulating unit 12a and a display unit 12b, is disposed in a prescribed position in the vending machine body 1.

The material reader 13, consisting of a known device for reading information stored in a prescribed information storage medium, reads information in a memory M1 (e.g. an IC tag, bar code or the like) provided on the package of a material G.

The control unit 14, composed of a microcomputer, is connected to the hot water tank 2, first through fifth material containers 3 through 7, cup delivery device 8, agitator 9, cup conveyance mechanism 10 for conveying cups, memory unit 11, remote controller 12 and material reader 13. In this configuration, though it is possible to alter the variety and prices of the beverages sold with the remote controller 12, setting of the beverage data in the memory unit 11 is restricted not to permit alteration as desired except in the cases to be described afterwards. A communication control unit 15, capable of communicating with a headquarters server S1 via a prescribed medium of communication (a common telephone line, the Internet or the like) is connected to the control unit 14. A connection unit 16 consisting of a USB port or the like is connected to the control unit 14, and an external memory M2 (e.g. a USB memory) storing any beverage data or a dedicated external terminal unit T can be connected to the connection unit 16. Thus the control unit 14, when it has received new beverage data from the headquarters server S1 via the communication control unit 15 or the external memory M2 storing new beverage data is connected to the connection unit 16, replaces the beverage data stored in the memory unit 11 with the new beverage data. In this process, ciphered data are used as the new beverage data, and the control unit 14 is provided with a function to decipher the ciphered data. The headquarters server S1, arranged on the part of the dealer of the beverages (e.g. a beverage manufacturer), ciphers beverage data created by the dealer and transmits them to the communication control unit 15 of the automatic beverage vending machine or sales office servers S2. The sales office servers S2, arranged on the part of the manager managing beverage vending machines, receive beverage data from the headquarters server S1 and supply them to the external memory M2.

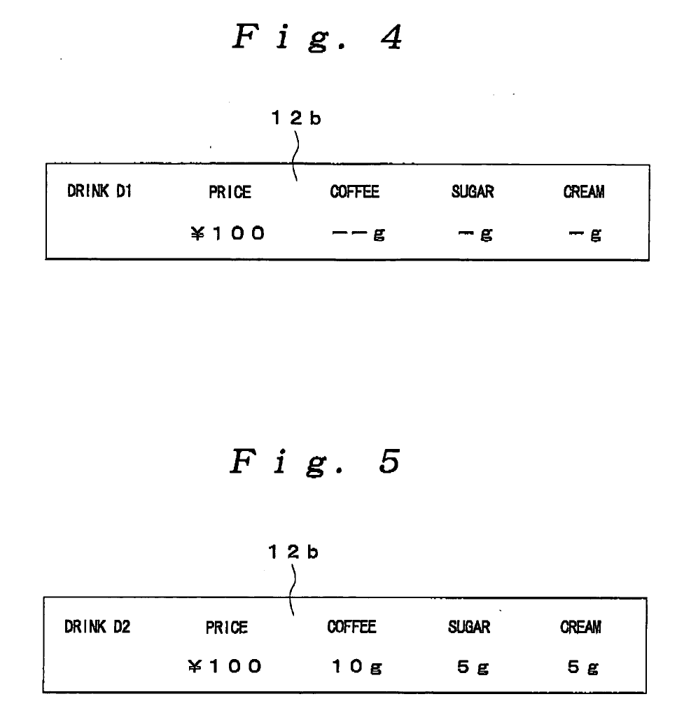

The control unit 14 is so configured, though allowing an operator under the manager to alter the variety and prices of the beverages sold with the remote controller 12 as desired, as not to permit alteration of the setting of beverage data in the memory unit 11 as desired except in the cases to be described afterwards in this configuration, the price of the beverage is displayed on the display unit 12b of the remote controller 12 as shown in FIG. 4, but not beverage data, such as the specific quantities of the materials to be used. The control unit 14 also is so configured as to permit alteration of the setting of beverage data in the memory unit 11 as desired when a prescribed password (e.g. what has been acquired with the permission of the dealer) is entered from the remote controller 12 to lift the restriction on such alteration or when a dedicated external terminal unit T for alteration use (e.g. what is possessed by the dealer) is connected to the connection unit 16 and such alteration is effected from the external terminal unit T. When alteration of the setting of beverage data is made possible, beverage data such as the specific quantities of the materials to be used, together with the price of the beverage, are displayed on the display unit 12b of the remote controller 12 as shown in FIG. 5.

In the beverage vending machine configured as described above, when a beverage and its optional taste are selected with the selector switches 1b, the beverage is prepared on the basis of beverage data on that beverage. Thus, when a cup A is delivered from the cup delivery device 8 to the cup conveyance mechanism 10, the cup A is moved down by the cup conveyance mechanism 10 to underneath the applicable ones of material containers 3 through 7, and the applicable materials are put into the cup A. If the selected beverage is coffee D1 with options to put sugar and cream in, a prescribed quantity each of the materials is delivered from the first material container 3, fourth material container 6 and fifth material container 7 on the basis of the pertinent beverage data. When the materials are put into the cup A, the cup A is moved underneath the agitator 9 by the cup conveyance mechanism 10, hot water is poured into the cup A from the hot water tank 2, and the materials and the hot water in the cup A are stirred by the agitator 9. In this process, the agitating by the agitator 9 is controlled (as to the duration, speed and so forth) on the basis of the beverage data. When the beverage has been prepared in this way, the cup A containing the beverage is conveyed by the cup conveyance mechanism 10 to the beverage delivery outlet 1g.

In this beverage vending machine, if for instance any new kind of beverage is to be added to the currently available ones by rewriting beverage data in the memory unit 11 by direct downloading from the headquarters server S1, when new beverage data are received from the headquarters server S1, beverage data in the memory unit 11 are replaced with the new beverage data from the headquarters server S1. When beverage data in the memory unit 11 are to be rewritten by connecting the memory M2, new beverage data are downloaded from the headquarters server S1 to sales office servers S2, at the same time beverage data in the sales office servers S2 are stored into the memory M2 and, when the memory M2 is connected to the control unit 14, beverage data in the memory unit 11 are replaced by the new beverage data from the memory M2. In this process, the control unit 14 determines the kinds of beverages that can be prepared from the materials held in the material containers 3 through 7, out of those covered by the beverage data newly stored into the memory unit 11, and excludes from the assortment of beverages that can be sold other beverages than those that can be prepared. For instance, the control unit 14 erases beverages that cannot be prepared from the screen listing the available beverages or switches the display to an indication of unavailability. Or any beverage that cannot be prepared is already offered for sale in the setting, it is made unavailable by switching the display of that beverage to that of a sold-out beverage.

Further, where any new kind of material is to be held in, for instance, the first material container 3 in this beverage vending machine, when information in the memory M1 provided in the container or the like of the material G to be put into the first material container 3 is read with the material reader 13, the type of that material is held in the memory unit 11 as data on the material held in the first material container 3. In that process the control unit 14, as in the foregoing process, determines according to beverage data in the memory unit 11 the kinds of beverages that can be prepared from the materials held in the material containers 3 through 7, excludes from the assortment of beverages that can be sold other beverages than those that can be prepared and, if any beverage that cannot be prepared is already offered for sale in the setting, makes it unavailable by switching the display of that beverage to that of a sold-out beverage.

As described above, since the beverage vending machine in this mode of implementing the invention is so configured that beverage data stored in the memory unit 11 can be replaced with another set of beverage data only by using prescribed data rewriting means, there is no possibility for beverage data to be arbitrarily altered on the part of the manager (operator or anyone else) of the vending machine, but beverages are always prepared on the basis of predetermined beverage data, Therefore, even where the same kind of beverage offered by a specific dealer are sold through a plurality of vending machines, the taste of the same kind of beverage does not vary from one machine to another, and it is made possible to always keep the quality of each kind of beverage uniform among all the vending machines.

Since in this configuration beverage data in the memory unit 11 are replaced with new beverage data by receiving beverage data transmitted from the headquarters server S1 by prescribed means of communication, the dealer of the beverages can directly rewrite the beverage data in the memory unit 11 via the headquarters server S1, and leakage of the beverage data can be prevented without fail.

Apart from the data rewriting means, beverage data in the memory unit 11 can also be replaced with new beverage data by storing beverage data transmitted from the headquarters server S1 to the sales office servers S2 into the external memory M2 and reading them out of the memory M2 connected to the connection unit 16. Therefore, even where connection to the headquarters server S1 is not accomplished via communication means, beverage data in the memory unit 11 can be rewritten. Incidentally, beverage data from the headquarters server S1 can as well be directly stored into the memory M2.

Furthermore, since beverage data created on the part of the dealer are cipherad, the ciphered beverage data are deciphered and the deciphered data are stored into the memory unit 11, this configuration is very effective in preventing beverage data from leaking out.

Also, the configuration enables beverage data in the memory unit 11 to be altered via the remote controller 12 by entering a prescribed password. Therefore, when for instance some special circumstance necessitates alteration of beverage data, if the dealer permits the alteration of beverage data, the manager of the vending machine can alter the beverage data by using a password acquired from the dealer.

Further, as it is made possible to alter beverage data in the memory unit 11 as desired by connecting to the connection unit 16 the dedicated external terminal unit T for use in altering the setting and manipulating this external terminal unit T, the manager of the vending machine can alter beverage data by using the external terminal unit T possessed by the dealer if the dealer permits alteration of the beverage data as in the foregoing case.

Also, the types of raw materials held in the material containers 3 through 7 are stored as material data in the memory unit 11 and, out of the kinds of beverages that can be prepared on the basis of beverage data in the memory unit 11, those that can be prepared fro the materials held in the material containers 3 through 7 are determined on the basis of the material data in the memory unit 11. Therefore, even where beverage data in the memory unit 11 are replaced with new beverage data or the types of materials held in the material containers 3 through 7 are altered, the kinds of beverages that can be prepared can be accurately determined.

In such a case, the indication of any beverage that cannot be prepared, out of the kinds of beverages set to be available, is altered to one of unavailability, and only those that can be prepared are offered for sale. Therefore, the user is prevented from selecting by mistake what cannot be prepared, and wrong actions to sell any unavailable beverage can be prevented without fail.

Furthermore, material data to be stored in the memory unit 11 are read out of the memory M1 by using the material reader 13. Therefore, by reading information out of the memory M1 provided on the container or the like of the material G is read when the material is held, there is no need to separately set the material type by using the remote controller 12, and the material data can be readily and accurately set. Or if the memory M1 is not provided on the container or the like of the material C, a memory storing material data can be fitted in advance to the front face or the like of each of the material containers 3 through 7, and read by using the material reader 13 at the time of putting the material in.

1. An automatic cup type beverage vending machine which comprises at least one material container for holding a beverage material and beverage data memory means storing, for each kind of beverage, a set of beverage data on the basis of which a beverage is prepared from the material in the material container, and sells the beverage which is prepared on the basis of the beverage data in the beverage data memory means, the beverage being contained in a cup when it is sold:
the automatic cup type beverage vending machine being provided with rewrite restricting means which allows beverage data stored in said beverage data memory means to be replaced with another set of beverage data only by prescribed beverage data rewriting means.

2. The automatic cup type beverage vending machine according to claim 1, wherein said data rewriting means receives beverage data transmitted from an external data transmitting source via prescribed communication means and rewrites beverage data in the beverage data memory means with new beverage data.

3. The automatic cup type beverage vending machine according to claim 1, wherein said data rewriting means reads beverage data from an external storage medium connected to a prescribed connection unit and replaces beverage data in the beverage data memory means with new beverage data.

4. The automatic cup type beverage vending machine according to claim 1, further provided with ciphered data deciphering means for deciphering beverage data ciphered by a prescribed data creating source as new beverage data to be stored in the beverage data memory means.

5. The automatic cup type beverage vending machine according to claim 1, wherein said rewrite restricting means is enabled to alter beverage data in the beverage data memory means as desired via a prescribed manipulating unit by entering prescribed restriction lifting information.

6. The automatic cup type beverage vending machine according to claim 1, wherein said rewrite restricting means is enabled by connecting a prescribed external device to alter beverage data in the beverage data memory means as desired by manipulating the external device.

7. The automatic cup type beverage vending machine according to claim 1, further provided with:
material data memory means for storing the types of materials held in said material containers as material data, and
determining means for determining the kinds of beverages that can be prepared from the materials held in the material containers, out of the kinds of beverages that can be prepared on the basis of beverage data in the beverage data memory means, on the basis of material data in the material data memory means.

8. The automatic cup type beverage vending machine according to claim 7, further provided with sale restricting means which enables to be sold only the kind or kinds of beverage determined by said determining means to permit preparation out of the kinds of beverages set as merchandise available for sale out of beverages that can be prepared on the basis of beverage data in said beverage data memory means.

9. The automatic cup type beverage vending machine according to claim 7, further provided with material data reading means for reading material data to be stored in said material data memory means out of a prescribed storage medium.
